(19) United States
(12) Patent Application Publication
(10) Pub. No.: US 2022/0148223 A1
(43) Pub. Date: May 12, 2022

(54) Lens Calibration System

(71) Applicant: Mo-Sys Engineering Limited, London (GB)

(72) Inventors: Michael Paul Alexander Geissler, London (GB); Simon Julier, London (GB); Robert North, London (GB)

(73) Assignee: Mo-Sys Engineering Limited, London (GB)

(21) Appl. No.: 17/433,794

(22) PCT Filed: Feb. 25, 2020
(86) PCT No.: PCT/GB2020/050446

§ 371 Date: Aug. 25, 2021

(30) Foreign Application Priority Data
Feb. 25, 2019 (GB) 1902517.0

(51) Int. Cl. G06T 7/80; G06T 7/20

(52) U.S. Cl. CPC G06T 7/80; G06T 2207/30204; G06T 2207/10016; G06T 7/20

(57) ABSTRACT

A lens calibration system for calibrating a lens of an image capture device, the lens calibration system comprising: a processor configured to receive from the image capture device a series of image frames of a scene at different rotational positions of the image capture device; The processor being configured to: Identify in the series of image frames elements representing a first marker located at a first known distance from the image capture device and a second marker located at a second known distance from the image capture device, the first and the second known distances being different to one another; track the identified elements representing each marker across the series of image frames; process the tracked elements to determine a characteristic parameter of the lens of the image capture device; and build a lens model for the image capture device in dependence on the determined characteristic parameter of the lens.

This invention relates to a lens calibration system in, for example, virtual production systems and real-time augmented reality systems.

Determining the characteristics of the lens of an imaging device is often an issue in TV and film production houses and studios when combining footage taken with different cameras or when integrating computer graphics into live action plates or live video footage. This is because images generated with camera systems are characterised with the optical properties of the camera systems with which they are generated such as field of view, lens distortion, chromatic aberration, vignetting and the like. Lens distortion, for example, is a nonlinear and generally radial distortion caused by a lens having a higher magnification in the image centre than at the periphery or vice versa. When integrating computer graphics into footage taken by an imaging device such as a camera, it becomes important to use lens calibration to determine the characteristics of the camera lens and then to apply those determined characteristics to the computer graphics that are to be added to the camera footage. In this way it becomes possible to generate computer graphics such as CGI which are aligned with the real-world optical properties of the camera system being used to generate the live footage. In turn this allows for the seamless integration of those computer graphics into live footage.

Available lens calibration processes are quite complex and therefore require expert teams to implement which take a long time. For example, lens distortion and viewing angles of an optical system can change not only when the zoom setting of a lens has been changed but also when the focus settings of the lens are changed. Consequently, lenses must be calibrated at several zoom and focal length settings. One common example is a 7×5 calibration where the lens is set at 7 different zoom settings and at each zoom setting, 5 focus settings are used resulting in 35 different lens settings being used for calibration.

In Lightcraft's optical marker system, black and white optical marker patterns are mounted on a board in a studio. For various camera settings, positions, and orientations the resulting set of images of the marker patterns are used to determine the characteristics of the lens. The matrices of data resulting from this calibration process are then used to apply corrections to rendered images being integrated with live footage in real time as the camera moves around the studio. It is a lengthy process, even if automated, and without a skilled team to implement and apply the calibration process, it is very easy for mistakes to be made and for the data to be invalid.

NCam's marker detection systems use specific markers within a studio, dedicated witness cameras mounted to a main camera, and image processing techniques to determine lens distortion. However, their markers need to be high contrast in order for the image detection system to work. As a result, any changes in lighting conditions or stray light in the studio that may significantly alter the contrast of the markers can cause the image processing to fail. Moreover, the quality of calibration is sensitive to the level of image noise generated by the witness cameras.

Vizrt's system achieves calibration through the comparison of off-set markers in real and virtual cameras. It matches real A4 sheets of paper that are placed on off-set lighting stands within the studio to equivalents recreated within the virtual camera. Initially, the papers appear like they are on top of each other despite being at a distance apart. A matrix of rows and columns (e.g. 3×5) is then built to measure the papers at 15 different points of the image. The camera is panned and tilted so that the real papers appear in a different point of the matrix. The virtual paper needs to be manually adjusted with a mouse to match the real one so that it is brought visually on top.

A typical process would look like:

7 zoom settings*5 focus settings*2 papers*3 rows*5 columns=1050 measure points

To align each measurement point takes 20 seconds, therefore 1050*20 seconds=21000 sec=350 min=5.8 hours which is quite a lengthy process

There is therefore a need for a less complex, less time consuming yet more accurate, efficient and user-friendly calibration system and method.

According to the present invention there is provided a lens calibration system for calibrating a lens of an image capture device, the lens calibration system comprising: a processor configured to receive from the image capture device a series of image frames of a scene at different rotational positions of the image capture device; The processor being configured to: Identify in the series of image frames elements representing a first marker located at a first known distance from the image capture device and a second marker located at a second known distance from the image capture device, the first and the second known distances being different to one another; track the identified elements representing each marker across the series of image frames; process the tracked elements to determine a characteristic parameter of the lens of the image capture device; and build a lens model for the image capture device in dependence on the determined characteristic parameter of the lens.

The processor may further be configured to identify in the series of image frames elements representing a third marker located at a third known distance from the image capture device; the third known distance being different to both the first and the second known distances.

The identified elements representing each marker may be arranged along a longitudinal axis of that marker. The received series of image frames may comprise image frames captured of the scene at different zoom and focal length settings of the image capture device. The determined characteristic parameter of the lens may be the entrance pupil location of the lens and/or the lens distortion and/or the chromatic aberration of the lens.

The received series of image frames may comprise a set number of image frames per second captured repeatedly of the scene at different rotational positions of the image capture device spanning a known duration. The received series of image frames may comprise a set number of image frames per second captured of the scene at a desired zoom and focal length settings of the image capture device. The different rotational positions of the image capture device may be about a rotational axis parallel to the longitudinal axis of the markers. The known duration may be 5 seconds. The set number of image frames may be 10 image frames per second.

The desired zoom may be selected from a range of 7 zoom settings and the desired focal length is selected from a range of 5 focus settings. The processor may be configured to identify one element of the identified elements representing a marker having a visually different appearance to the rest of the identified elements as a reference feature element for that marker. The processor may be configured to identify the colour of the identified elements representing a marker from a range of available colours. The processor may be configured to identify an element having a colour different to the colour of the rest of the identified elements representing a marker as the reference feature element for that marker.

The identified elements representing a marker represent a string of lights. Each element of the identified elements may represent a light of the string of lights that is switched on. The processor may be configured to distinguish between the markers in dependence on the colour of the identified elements representing each marker. The identified elements may represent a marker represent a strip of LED lights. The strip of LED lights may comprise 200 LED lights.

According to a second aspect there is provided a method of lens calibration for calibrating a lens of an image capture device, the method comprising: carrying out the following steps by a processor: receiving from the image capture device a series of image frames of a scene at different rotational positions of the image capture device; identifying in the series of image frames elements representing a first marker located at a first known distance from the image capture device and a second marker located at a second known distance from the image capture device, the first and the second known distances being different to one another; tracking the identified elements representing each marker across the series of image frames; processing the tracked elements to determine a characteristic parameter of the lens of the image capture device; and building a lens model for the image capture device in dependence on the determined characteristic parameter of the lens.

According to a third aspect there is provided a system for generating a modified series of image frames in accordance with a lens model, the system comprising: a processor configured to: receive a series of image frames from an image generation system; receive a lens model from a lens calibration system for calibrating a lens of an image capture device according to the first aspect, the lens model including a characteristic parameter of the lens of the image capture device; and apply the characteristic parameter of the lens model to the received series of image frames to generate a modified series of image frames in accordance with the lens model.

According to a fourth aspect there is provided a method of generating a modified series of image frames in accordance with a lens model, the method comprising: carrying out the following steps with a processor: receiving a series of image frames from an image generation system; receiving a lens model using a method of lens calibration for calibrating a lens of an image capture device according to the second aspect, the lens model including a characteristic parameter of the lens of the image capture device; and applying the characteristic parameter of the lens model to the received series of image frames to generate a modified series of image frames in accordance with the lens model.

According to a fifth aspect there is provided a system for generating a processed video stream, the system comprising: a processor configured to: receive an incoming video stream comprising a series of image frames captured by an image capture device; receive a lens model for the image capture device from a lens calibration system for calibrating the lens of the image capture device according to the first aspect; receive a modified series of image frames from a system for generating a modified series of image frames in accordance with the received lens model according to the third aspect; and combine the received modified series of image frames with the series of image frames of the incoming video stream to generate a processed vide stream.

According to a sixth aspect there is provided a method of generating a processed video stream, the method comprising: carrying out the following steps by a processor: receiving an incoming video stream comprising a series of image frames captured by an image capture device; receiving a lens model for the image capture device by using a method of lens calibration for calibrating the lens of the image capture device according to the second aspect; receiving a modified series of image frames using a method of generating a modified series of image frames in accordance with the received lens model according to the fourth aspect; and combining the received modified series of image frames with the series of image frames of the incoming video stream to generate a processed video stream.

According to a seventh aspect, there is provided a method of fine tuning the calibration of a lens of an image capture device, the method comprising: carrying out the following steps by a processor: receiving from the image capture device a series of image frames of a scene at different rotational positions of the image device; identifying in the series of image frames an element representing a marker located at a known distance from the image capture device; using a calibration model of the lens to render a virtual representation of the marker element in the series of image frames; determining an offset between the location of the element representing the marker and the virtual representation of the marker element in the series of image frames; updating the calibration model of the lens in accordance with the determined offset.

The present invention will now be described by way of example with reference to the accompanying drawings. In the drawings:

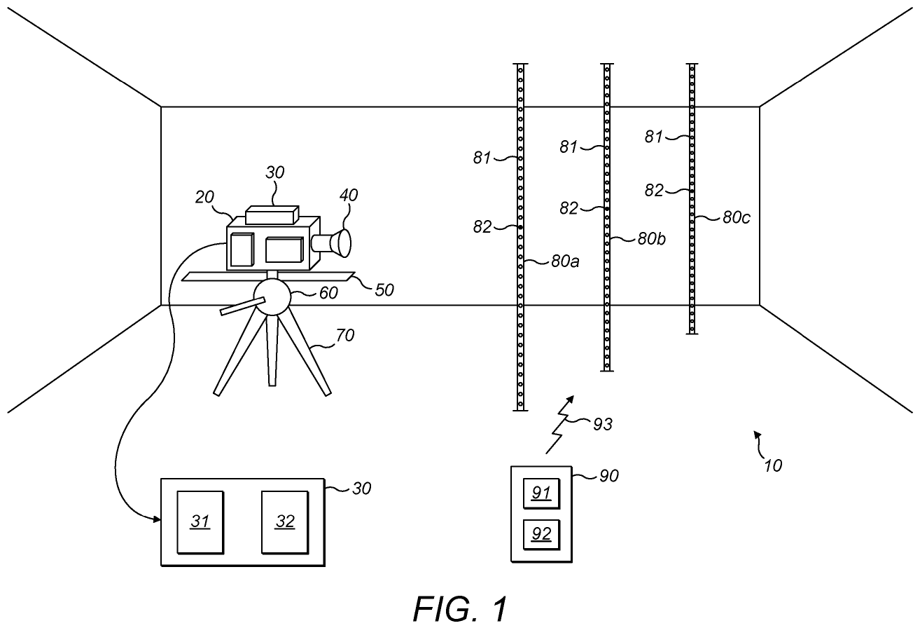

FIG. 1 shows an example of a lens calibration system with a camera installation in a production facility.

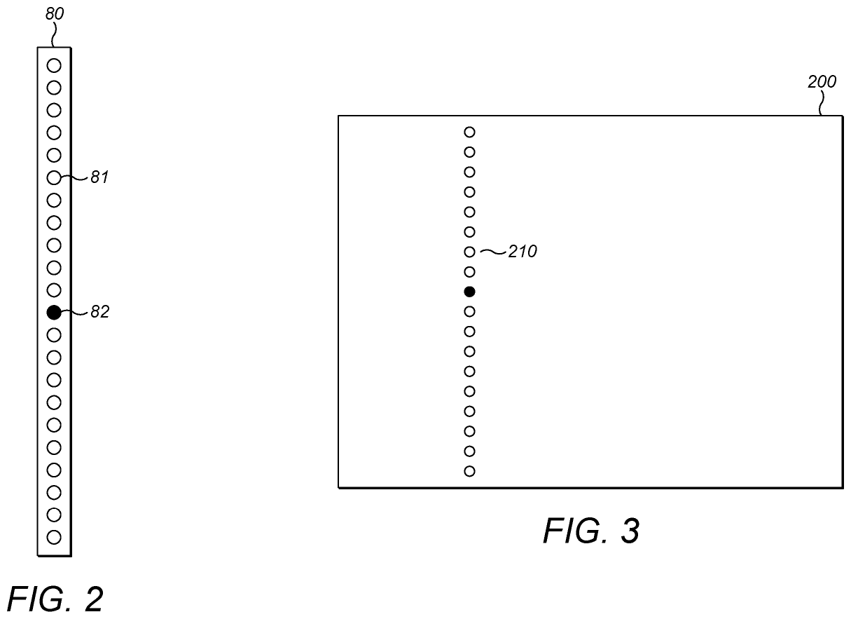

FIG. 2 shows an example of a marker.

FIG. 3 shows an example image frame from a calibration data set including an image of the marker of FIG. 2.

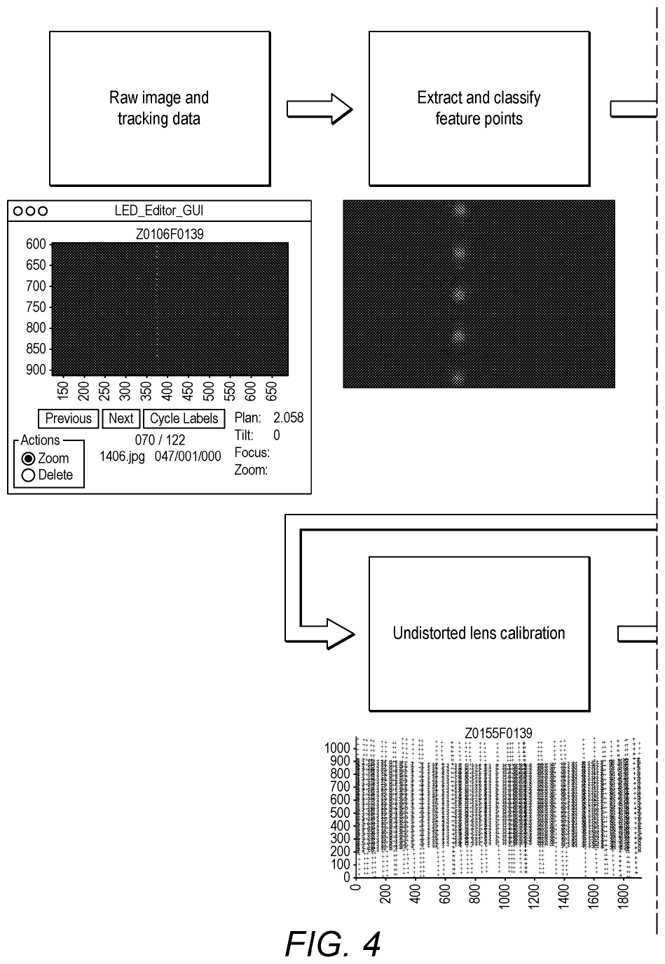

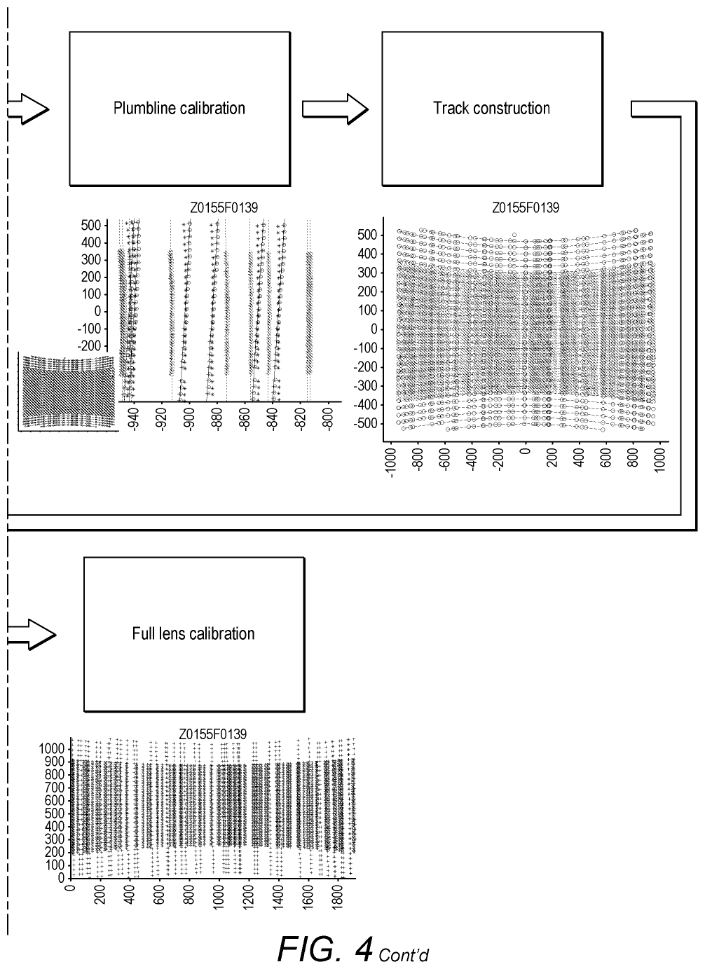

FIG. 4 illustrates a set of image processing steps in the calibration system.

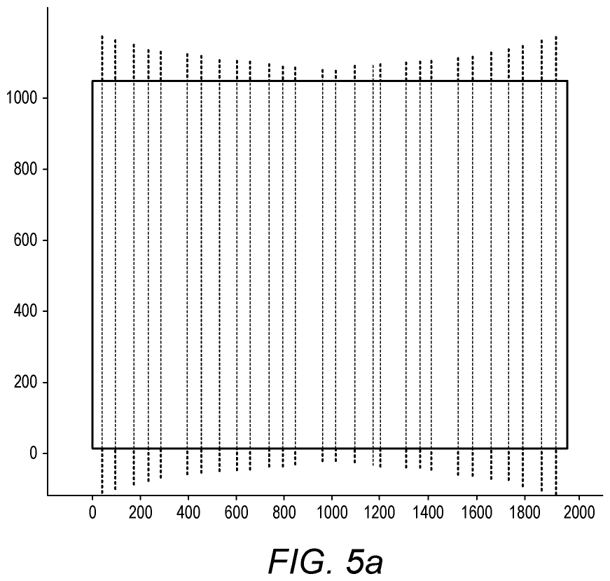

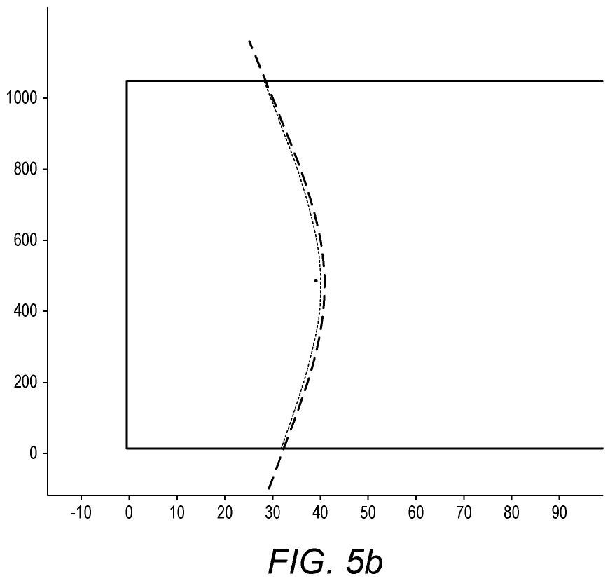

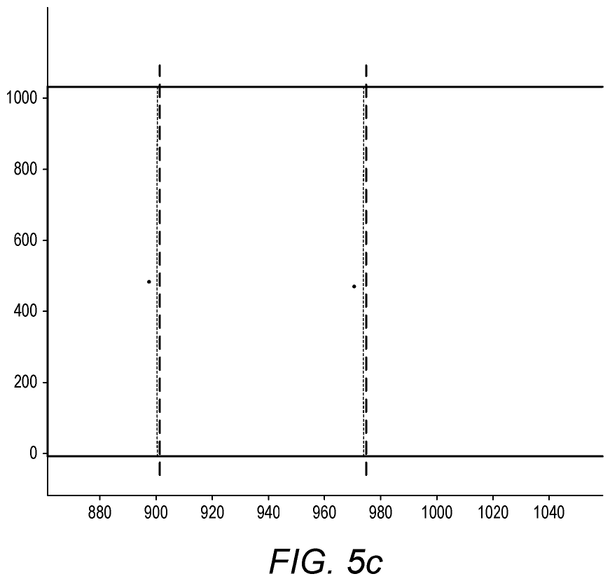

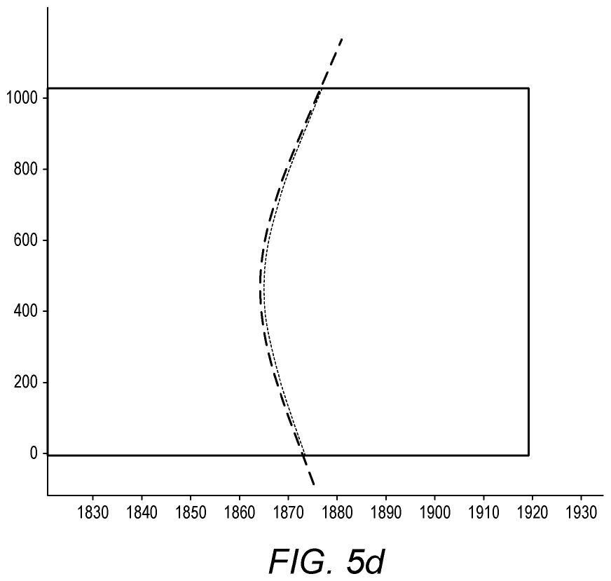

FIGS. 5a to 5d illustrate example calibration results using the calibration system of FIG. 1.

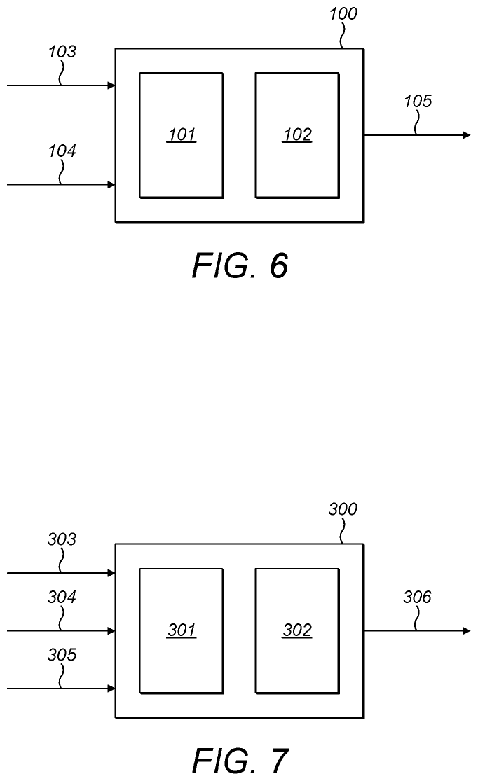

FIG. 6 is a schematic illustration of a system for generating a modified series of image frames in accordance with a lens model.

FIG. 7 shows a schematic illustration of a system for generating a processed video stream.

FIG. 1 shows a typical studio 10 comprising an image capture device such as the camera system 20 having an optical system such as lens 40. Camera 20 is capable of capturing video. Camera 20 is operable at a range of zoom, focal length and aperture settings. Lens 40 is a variable zoom lens and may be operated either manually by a manual operator operating the camera 20 or it may be provided with a motor (not shown) by which the zoom of the lens can be altered remotely. By adjusting the zoom of the lens, the camera's field of view can be narrowed or widened. The camera 20 may be mounted on a pan and tilt head 60. The pan and tilt head 60 allows the direction in which the camera is point to, to be adjusted. The pan and tilt head 60 may be provided with motors (not shown) for adjusting its pan and tilt. Tilting involves rotating the camera 20 about a generally horizontal axis so that the camera's field of view is raised and lowered. Panning involves rotating the camera 20 about a generally vertical axis so that the camera's field of view is moved from side to side. By providing the camera 20 with a motorised head 60 the camera's pan and tilt can be controlled remotely. The camera 20 may include a high precision encoder (not shown) operable to measure the rotation of the camera when it is panned or tilted. The camera 20 may be mounted on a rail 50. The camera 20 may be translated along the length of the rail 50 to allow further adjustment of the camera position as well as its field of view. The camera may be mounted to a support base such as a tripod 70. The pan and tilt head 60 and the rail 50 advantageously allow for further adjustments to be made to the camera's field of view and position even after it is mounted to a tripod. In principle, by providing the camera 20 with a motorised variable zoom and pan and tilt head 60, the camera's field of view can be remotely controlled without the need for an operator at the camera.

FIG. 1 also shows a plurality of markers 80a, 80b and 80c located at a range of known distances from the camera 20. At least two markers are required. Alternatively, an optional three or more markers may be used. Each marker is located at a different distance from the camera 20. The different distances may be in the range 2 to 12 meters from the camera 20. Preferably, the nearest marker may be located at 2.2 meters from the camera 20, the furthest marker may be located at 11.5 meters from the camera 20 and the intermediate marker may be located at 3.7 meters from the camera 20. The markers may be located at any known distance from the camera 20. Each marker has a longitudinal axis. The markers are generally positioned so as to share a common orientation. For example, each marker is located such that its longitudinal axis is substantially parallel to the longitudinal axis of the other markers. Each marker may comprise at least two visually distinct feature elements arranged along its longitudinal axis.

FIG. 2 shows an example of a marker 80. Marker 80 comprises elements 81, 82 which can be advantageously arranged as an array of visually distinct feature elements along the longitudinal axis of the marker 80. Using a marker 80 having an array of elements 81, 82 is advantageous as such a marker would provide many more measurement points in the captured images than markers used in prior systems. This in turn would mean a more accurate calibration system. The term “feature” refers to any identifiable or detectable pattern in an image. One feature element 82 of the array of feature elements may be arranged to visually appear in a different manner to the rest of the feature elements 81, thus acting as a reference feature element for the marker 80. For example, reference feature element 82 may be arranged to be a different shape, colour, or size than the other feature elements 81. The array of visually distinct feature elements may comprise a string of lights or an array of retroreflective elements such as stickers. Each light of the string of lights may be independently operable to be switched on or off. Each light of the strip of lights may be independently operable to be set to (i.e. be lit in) a colour from a range of available colours. The reference feature element 82, for example a light of the string of lights, may be set to be a different colour to the rest of the feature elements 81 so as to appear in a visually distinct manner from the rest of the feature elements 81. Alternatively, it could be set so that it is lit and turned off in quick succession (i.e. it blinks) when the other feature elements 81 are lit continuously. Each string of light may be configured to be set to a colour different from the colour of the other strings of light. For example, the lights of marker 80a may be configured to be lit in a first colour e.g. red, the lights of marker 80b may be configured to be lit in a second colour e.g. green and the lights of marker 80c may be configured to be lit in a third colour e.g. blue. In this way the different markers 80a, 80b, 80c can be visually distinguished from one another in the images captured of them by the camera 20. Where the array of visually distinct feature elements comprises an array of retroreflective elements, the same colour lighting configurations may be used by having each of the retroreflective elements lit in a different colour from a range of colours by shining a light of a desired colour in the direction of the desired retroreflective element.

The string of lights may be a strip of LED lights. The strip of LED lights may be any length and comprise a plurality of LED lights. Each strip of LEDs may be about 3 meters long. Each strip of LEDs may comprise about 60 LED lights per meter (i.e. about 200 LED lights per strip of LEDs). The strips of LED lights are advantageous in that they are readily available and inexpensive to purchase. They also provide very small measuring point elements in the form of each LED (around 50 K smaller than the A4 sheets of paper which form the measuring point elements of the Vizrt system described above) which in turn can provide better precision when it comes to determining the characteristic parameters of the camera's optical system. This will be described in more detail below.

The strip of lights may be operably coupled to a remote controller 90 by a communications cable or a wireless data link. The strip of lights would thus be remotely operable in dependence on a received signal 93 from the remote controller 90. In this way each light of the strip of lights may be independently operable to be switched on or off. For example, the received signal from the remote controller 90 may cause every light to be switched on such that all of the lights of the strip of lights are lit. Alternatively, the received signal from the remote controller 90 may, for example, cause every third light of the strip of lights to be switched on. In this way the spacing between the lit lights of the strip of lights can be adjusted. The received signal from the remote controller 90 may also determine the colour in which each light is lit. Remote controller 90 comprises a processor 91 and a memory 92. The memory 92 stores in non-transient form program code executable by the processor 91 to cause it to perform the functions of the lens calibration system 90.

A lens calibration system 30 is operatively coupled to the camera 20 by a communications cable or a wireless data link. The lens calibration system 30 comprises a processor 31 and a memory 32. The memory stores in non-transient form program code executable by the processor to cause it to perform the functions of the lens calibration system 30 as described herein. The lens calibration system 30 receives a video signal from the camera 20. The video signal comprises a video stream which in turn comprises a series of image frames. The series of image frames captured by the camera 20 are transmitted to the lens calibration system 30 to be received by processor 31 for processing. The series of image frames received by processor 31 make up the calibration data set used by the lens calibrations system 30 for calibrating lens 40 of the camera 20.

First, we describe the way in which the series of image frames are captured. The series of image frames are captured at different rotational positions of the camera 20. Preferably, the camera 20 is rotated about an axis parallel to the longitudinal axis of the markers 80. Preferably, the camera 20 is rotated about a single axis in dependence on the longitudinal axis of the markers 80 while capturing the series of image frames. Thus, when the longitudinal axes of the markers are positioned at a generally vertical axis the series of image frames are captured while the camera is panned from right to left or vice versa. In this way the captured series of image frames will include images of the markers that appear to shift sideways in the opposite direction to the panning direction of the camera as the captured series of image frames are stepped through. For example, if the camera is panned from left to right while capturing a series of image frames of marker 80a, then marker 80a appears to be travelling from the right side of the scene to the left side of the scene as the captured series of image frames are stepped through. Alternatively, when the longitudinal axes of the markers are positioned at a generally horizontal axis the series of image frames are captured while the camera is tilted from a raised position to a lowered position or vice versa. In this way the captured series of image frames will include images of the markers that appear to shift in the opposite direction to the tilting direction of the camera as the captured series of image frames are stepped through. For example, if the camera is tilted from a lowered position to a raised position while capturing a series of image frames of marker 80a, then marker 80a appears to be travelling in a downward direction along the scene as the captured series of image frames are stepped through.

To capture the series of image frames at different rotational positions of the camera 20, the camera is rotated from a desired starting point for a desired duration. For example, the rotation may span a period of five seconds. The camera is configured to capture a desired number of image frames per second. For example, the camera may be configured to capture ten image frames per second. Thus, the camera may be configured to take ten image frames per second while the camera is rotated for five seconds resulting in the capturing of fifty image frames during the five seconds long rotational sweep of the camera 20. The camera may be rotated by an operator. Alternatively, the camera may be rotated remotely using the motorised head 60. In either case, information in relation to the rotational position of the camera 20 is transmitted from the high precision encoder to the lens calibration system 30 to be received by processor 31.

Because the markers 80 comprise an array of elements arranged along their longitudinal axis, the camera need only capture images during a rotational sweep around the axis parallel to the longitudinal axes of the markers 80 in order to build up a calibration dataset having a gird of measurement points. Thus, when the longitudinal axes of the markers are positioned at a generally vertical axis only a panning motion of the camera 20 is required when capturing the series of images. Alternatively, when the longitudinal axes of the markers are positioned at a generally horizontal axis only a tilting motion of the camera 20 is required when capturing the series of images. This is advantageous as unlike prior systems which require both a tilting and a panning motion in order to build up a calibration data set having a grid of measurement points, only a tilting or panning motion is required thereby reducing the time that it takes to build the required calibration data set.

Certain characteristic parameters of an optical system such as lens distortion and the viewing angle change at different zoom and focus settings of the lens. To account for this issue, it is desirable to carry out lens calibration at several zoom and focus settings. For this reason, the series of image frames are also captured at a number of different zoom and focus settings of the optical system 40. For example, to carry out 7×5 calibration, the lens 40 is set to seven different zoom settings and at each zoom position, 5 different focus settings are used resulting in 35 different lens settings. A series of image frames are then captured at each of these different lens settings while the camera is rotated (e.g. either panned or tilted in dependence on the orientation of the longitudinal axes of the markers 80) for a known duration. For example, the lens 40 is set to the first zoom and focus settings and ten image frames per second are captured during a five seconds rotational sweep of the camera 20 to produce a first series of image frames at those settings. The lens 40 is then set to the first zoom setting and the second focus setting and another ten image frames per second are captured during another five seconds rotational sweep of the camera 20 to produce a second series of image frames at those settings. This process is repeated until a series of image frames have been captured at all the different focus settings for the first zoom position. Then the second zoom setting is used with each of the focus settings during further rotational sweeps of the camera 20 until a series of images are captured for all 35 different lens settings.

A 7×5 calibration data set captured in the manner described above provides many more measurement points resulting in more accurate calibration results than in previous systems. For example, only one marker 80 being captured 10 times per seconds during a 5 second rotation move at 7 different zoom settings and 5 different focus settings and having around 200 LEDs would yield 350,000 measurement points:

7 zoom settings*5 focus settings*200 LEDs*50 lines=350,000 measurement points

That is around 333 times more measurement points which are much finer than the system of Vizrt which only provides 1050 measurement points in the form of A4 sheets which are considerably larger (about 50 K times larger) than an LED light. The smaller size of the measurement points provides an advantage in that even when they are imaged from a zoomed in viewing point, they would still be distinguishable from each other in the resulting image. In contrast when an A4 sheet is used the resulting zoomed in image may be half covered by a single measurement point (i.e. the A4 sheet). Alternatively, depending on the focus distance being used the target A4 sheet could appear fully blurred in the captured image. These factors can adversely affect the accuracy and reliability of such calibration data.

Additionally, the inventors have found that it takes around 30 seconds to setup the different zoom and focus settings on the camera and to capture the frames during a rotational movement of the camera resulting in the whole capturing process taking around 17.5 minutes to complete:

7 zoom settings*5 focus settings*30 sec=1050 sec=17.5 mins

That is 20 times faster than the nearly 6 hours that it takes to prepare a calibration data set for the system of Vizrt.

As previously described, the calibration data set is received by processor 31 of the lens calibration system 30 for processing. The processor is configured to identify in the images, elements representing the markers 80a, 80b, and 80c. For example, the elements would represent the string of light representing marker 80a, with each element representing one lit light of the string of lights making up marker 80a. FIG. 3 shows an example image frame 200 from a calibration data set including an image representation 210 of a marker 80 appearing as a dotted line on the image frame 200. The fact that the spacing between the lit lights of the string of lights during image capture can be adjusted is advantageous as it aids in the identification of each light during the image processing stage. This is because it is possible for the representations of the lights to run into each other and be fuzzy and out of focus when during the capturing of their image, the focus and zoom settings of the camera 20 are not ideal for the location of the marker to which the lights belong. In such circumstances the spacing of the lit lights may be increased to provide better representations of the lit lights in the captured image frames. This could be achieved for example by controlling the strings of light to only have every third light lit. The processor 31 is further configured to identify certain characteristics of the identified elements such as their colour, size and shape. This can be achieved using machine vision algorithms known in the art.

Having identified each element of a marker 80, the processor 31 is also configured to classify the identified elements in dependence on their visual appearance or characteristic. For example, the processor may classify an identified element as a normal feature element 81 or as a reference feature element 82 in dependence on the identified element's appearance (e.g. colour, size or shape) or its characteristic (e.g. whether the element is continuously lit or blinking). An element may be classified as a reference feature element 82 if the processor identifies its appearance or characteristic to be different to the rest of the identified elements representing a marker 80. The processor may identify an array of dotted lines (or in other words an array of identified elements) along the same axis as representing a single marker. The processor may distinguish between the different markers 80a, 80b, and 80c in dependence on the identified colour of the identified elements representing each of those markers.

Once the identified elements have been classified, the processor 31 will be able to track the movement of each identified element across the different image frames and at the different zoom and focal length settings. This information is useful when running calibration algorithms on the calibration data set for determining characteristic parameters of the optical system such as lens distortion where the lens calibration system is trying to identify the resulting curvature of the image representations of the markers induced by lens distortion. Or when determining the chromatic aberration introduced by an optical system by monitoring the difference in the optical speed of the differently coloured elements across the image frames because different wavelengths of the different colours travel at different speeds. Having this tracking information is also of advantage in making the system more user friendly. This is because the environments in which the proposed calibration system is to be used is not a perfect laboratory environment and there may be occasions, for example, when an operator may not position an LED strip to be perfectly vertical. It may for example be off by a degree. But even such a small error could result in a 10-pixel difference between the top and bottom LEDs as represented in the captured images. The ability to track each measurement point (e.g. LED) as represented in the captured images can alleviate such problems and the resulting errors.

Using this data, the processor 31 can determine several characteristic parameters of the optical system 40 such as its entrance pupil location, lens distortion, chromatic aberration, vignetting and the like.

### Entrance Pupil Distance

In an optical system, the entrance pupil is the optical image of the physical aperture stop, as ‘seen’ through the front of the lens system. If there is no lens in front of the aperture (as is the case in a pinhole camera), the entrance pupil's location and size are identical to those of the aperture. Optical elements in front of the aperture will produce a magnified or diminished image that is displaced from the location of the physical aperture. The entrance pupil is usually a virtual image lying behind the first optical surface of the system. The location of the entrance pupil is a function of the focal length and focus position of the lens. The geometric location of the entrance pupil is the vertex of a camera's angle of view and consequently its centre of perspective, perspective point, view point, projection centre or no-parallax point.

This point is important in, for example, panoramic photography, because the camera must be rotated around it in order to avoid parallax errors in the final, stitched panorama.

It is the size of the entrance pupil (rather than the size of the physical aperture itself) that is used to calibrate the opening and closing of the diaphragm aperture. The f-number (“relative aperture”), N, is defined by N=f/EN, where f is the focal length and EN is the diameter of the entrance pupil. Increasing the focal length of a lens (i.e., zooming in) will usually cause the f-number to increase, and the entrance pupil location to move further back along the optical axis.

With most lenses, there is one special point around which one can rotate a camera and get no parallax. This special “no-parallax point” is the centre of the lens's entrance pupil, a virtual aperture within the lens. When the same scene is captured from a slightly different point of view, the foreground will be shifted in relation to the background. This effect is called the Parallax and occurs when a camera and lens are not rotated around the entrance pupil of the lens. It is therefore desirable to know the location of an optical system's entrance pupil or in other words its point of no parallax such that any CGI can be made to match the parallax properties of the optical system generating a stream of video.

The lens calibration system 30 uses its processor 31 to compute the lens' entrance pupil location using known mathematical methods which make use of the known distances of two of the markers 80 and the information received from the high precision encoder in regard to the rotational position of the camera 20 at the time of the image frame capture. All that is required is two measurements from an image frame including two markers 80 at different known distances to a common single point on the lens 40/camera 20 (one near and one far). Because the lens field of view angle is constant for the two measurements and the true angular origin of the lens is the same for both the near and far measurements, it is possible to calculate the offset distance (otherwise known as the entrance pupil distance) from the common measurement point to the location of the entrance pupil of the lens.

### Lens Distortion

In pinhole projection, the magnification of an object is inversely proportional to its distance to the camera along the optical axis so that a camera pointing directly at a flat surface reproduces that flat surface in an image. However, other types of optical projection can produce an effect called lens distortion. Distortion can be thought of as stretching the produced image non-uniformly, or, equivalently, as a variation in magnification across the field. While distortion can include arbitrary deformation of an image, the most pronounced modes of distortion produced by conventional imaging optics are “barrel distortion”, in which the centre of the image is magnified more than the perimeter and the reverse “pincushion distortion”, in which the perimeter is magnified more than the centre.

There are different known ways of modelling lens distortion and different known approaches to finding the parameters of the lens distortion model that fit the distortion of an actual camera best. Advantageously automatic calibration algorithms exist that can find these parameters without any user intervention. The Plumb-line technique is one such method since it only requires some straight lines visible in an image. Plumb-line methods generally rely on the process of optimizing the distortion correction parameters to make lines that are curved by radial distortion straight in the corrected imagery. The objective function for optimization can be formulating by undistorting the line segments and measuring the straightness by fitting a straight line. The distortion can then be found by fitting these curves to the distorted line segments.

The ability to undistort the images is important when integrating CGI and live action images. The integration of computer-generated graphics and an original image starts by tracking the camera providing the live action images. If the lens distortion is not removed prior to tracking, the constraints used by a camera matching algorithm (the process of calculating a camera's parameters such as translation, orientation and focal distance of the original camera based on only image sequences. This is important when integrating CGI into live action footage, since the virtual camera has to move exactly the same way as the original camera), which supposes a pin-hole camera model, will not hold, thus it will not generate a precise enough solution. After removing lens distortion and successful camera matching the computer-generated elements may be rendered. Since rendering algorithms support only pin-hole camera models, the rendered images cannot be combined with the original and distorted footage. The best solution is not to composite the CGI elements with the undistorted version of the original images used for tracking. This is because the un-distortion process worsens the quality of the live action images. To overcome this problem lens distortion is applied to the CGI elements that are later composited with the original footage. The advantage of this approach is that the rendered images can be generated at any resolution, thus the quality after applying lens distortion remains excellent.

FIG. 4 shows some of the main steps in the lens calibration system 30 for calibration of the lens 40. The processor having received the series of image frames including tracking data, identifies the elements representing the markers by extracting and classifying the feature elements in the image frames. The processor 31 then applies plumb-line calibration using this information to estimate the distortion properties of the lens 40. These estimated distortion properties are then used by the processor 31 to create an undistorted image which is then used to work out the trajectories of the different identified elements representing the marker elements. This trajectory data is then used in two optimisation steps to progressively refine the distortion estimates. The lens calibration system 30 can thus produce distortion estimates for the lens 40 at each zoom and focus setting. The system 30 has been shown to produce errors of typically 5 pixels using this methodology. FIGS. 5a to 5c show an example set of results. The actual measurements are shown in a lighter dotted line outline and the predictions from the calibration system are shown in the darker stroked line outlines.

For example, the markers appear as dotted straight lines in the centre of the captured images. However, the dotted lines will appear as curved lines on the sides of the captured images as distortion increases near the sides of a lens. The reference feature element 82 of the marker will appear in one colour and the rest of the feature elements will appear in a different colour when colour is being used to visually distinguish the reference feature element 82 from the rest of the feature elements 81. As the locations of the feature elements are known in a curved line, when the distortion properties of the lens are known those feature elements can be projected onto a straight line. The offset of each of the feature elements on the curved lines can be as much as 50 pixels due to lens distortion and quite noticeable to an observer.

It is thus important that lens distortion is taken into account so that composite images including real images and CGI can be generated seamlessly.

The processor 31 may consider each differently coloured maker separately. Each marker may be set to a different colour alternately. In this way lens distortion parameters may be estimated for each colour separately.

### Chromatic Aberration

Another characteristic property of the lens 40 which can be determined by the lens calibration system 30 using the same methodology as described above is the chromatic aberration of the lens 40.

As the refractive index of a transmittive medium is dependent on the wavelength of light, dispersion occurs, when white light transmits such a medium. Refraction is stronger for light of short wavelengths, for example blue, and less intensive for light of long wavelengths, for example red. Different kinds of glasses cause refraction or dispersion of various intensities. The same effects occur in any optical system comprising lenses. This leads to chromatic aberration. For example, when an image frame includes an image of all three markers 80a, 80b, and 80c each in a different colour, it can be seen that the differently coloured identified elements belonging to each marker travel at a different optical speed across the series of image frames that have been captured during a single panning rotation of the camera 20. A typical difference in distance of about 5 to 10 pixels for the different coloured marker elements have been observed. Chromatic aberration is thus another lens characteristic which would be of interest to estimate and correct for, in final composite images including real image and CGI.

Again, the processor 31 may consider each differently coloured maker separately. Each marker may be set to a different colour alternately. In this way chromatic aberration parameters may be estimated for each colour separately.

Once the characteristic parameters of the optical system have been determined, a model of the optical system can be built by the calibration system 30. Said model being used for applying said characteristic parameters of the optical system to computer generated graphics (e.g. CGI). FIG. 6 shows a schematic illustration of a system 100 for generating a modified series of image frames in accordance with such a lens model. System 100 comprises a processor 101 and a memory 102. The memory 102 stores in non-transient form program code executable by the processor 101 to cause it to perform the functions of the system 100. The processor 101 is configured to receive a series of image frames 103 from an image generation system (e.g. CGI), to receive a lens model 104 including characteristic parameters of a desired lens from the lens calibration system 30 and to apply the characteristic parameters of the lens to the received series of image frames to generate a modified series of image frames 105 in accordance with the lens model. In this way, the characteristic parameters of an optical system 40 (e.g. distortion, chromatic aberration and vignetting, etc.) can be applied to computer generated graphics for later use in composite images that include live video images as well as CGI.

FIG. 7 shows a schematic illustration of a system 300 for generating a processed video stream. System 300 comprises a processor 301 and a memory 302. The memory 302 stores in non-transient form program code executable by the processor 301 to cause it to perform the functions of the system 300. The processor 301 is configured to receive an incoming video stream 303 comprising a series of image frames captured by an image capture device such as camera 20, receive a lens model 304 for the camera 20 from the lens calibration system 30 for calibrating the lens 40 of camera 20, receive a modified series of image frames 305 from the system 100 for generating a modified series of image frames in accordance with the received lens model and combine the received modified series of image frames with the series of image frames of the incoming video stream to generate a processed video stream 306. In this way, computer generated graphics (e.g. CGI) and original images (e.g. live action images) captured by a camera 20 can be integrated to produce a final processed (e.g. composite) video stream either during post production or in real-time (e.g. real-time augmented reality systems). Systems 100 and 300 are shown as two distinct systems, however these systems may be combined into one. The lens calibration system 30, and the systems 100 and 300 are operably coupled with one another by a communications cable or a wireless data link so that data can flow from one system to another.

The lens calibration method and system described above provide a less complex, less time consuming yet more accurate, efficient and user-friendly way of calibrating an optical system 40 of an image capture device such as camera 20 than previous systems. However, it should be noted that certain characteristic parameters of an optical system such as lens distortion are not identical for the same lens types. Furthermore, some of the characteristic parameters of a lens which include distance offsets (e.g. the entrance pupil distance, distortion, field of view, etc.) are prone to shifting when a lens 40 is removed from a camera 20 and then put back again. Therefore, while the full lens calibration method can be usefully employed to build a model of a particular type of lens, it would be advantageous to use a fine-tuning process for a particular combination of a camera 20 and a lens 40 to ensure that the lens model obtained from the lens calibration system 30 is as accurate as possible. Given such fine-tuning steps would need to be performed more often than a full calibration, the tuning process needs to be very simple and effective.

To do this, the same camera installation set up as shown in FIG. 1 can be utilised. However, in this case only a single marker element located at a known distance from the camera 20 is needed. The single marker element may be any one of the array of feature elements 81, 82 of marker 80. A series of image frames are then captured in the same way as described above in relation to the lens calibration system 30 with the difference that images are captured during both a tilting and a panning motion of the camera 20 to produce a fine-tuning calibration data set. The series of images captured by the camera 20 thus result in a series of measurement points in the data set in the form of the marker element. The fine-tuning process also comprises the generation of a virtual measurement point corresponding to the real marker element in the series of captured image frames using the existing lens model. The images are then viewed on a display screen to see if the image of the real marker element and the virtual marker element match. If an offset exists and the two points do not match exactly, the virtual marker element is moved so as to be located on top of the image of the real marker element. This movement will provide the existing offset between the model of the lens acquired from the lens calibration system 30 and the current calibration state of the lens 40 and the camera 20. This offset information is then used to automatically update the model of the lens 40 to obtain the current calibration settings for the camera 20 and lens 40 combination.

Advantageously, this process could be further automated in the following way. Once more only a single marker element located at a known distance from the camera 20 is needed. The single marker element may be any one of the array of feature elements 81, 82 of marker 80. The single marker element is set to blink at a rate similar to the rate at which the camera 20 is configured to capture image frames per second such that the marker element is lit during the capturing of one frame and off during the capturing of the next frame by the camera 20. For example, if the camera 20 is set to capture 10 frames per second then the marker element is synchronised to blink 10 times per second as well (i.e. to switch between a lit state and an off state 10 times per second so that the marker element is on for 5 out of the 10 frames captured during a second). This can be done by genlocking the rate of image capture of the camera 20 with the marker element's blinking rate. The processor 31 can then use known techniques such as a difference key to identify the pixels representing the marker element in the captured images. Difference keying is a technique in which an image of a desired subject (in this case the marker element) is captured against a complex background and then an image of the complex background alone without the desired subject is used to produce the difference between the two images to in turn produce an image of the subject with the complex background removed. Once the pixels representing the marker element in the series of captured image frames have been identified, the processor 31 automatically matches the virtual representation of the marker element with the identified representation of the marker element. In this way, the manual step of having to match the virtual marker element with the identified representation of the marker element across the series of images is eliminated and the automatic modification of the lens model becomes much faster and more accurate.

Whilst it is described above that at least two markers are required, in an alternative embodiment, it may be possible to use only a single marker for the calibration. This will not provide calibration as quickly as using two or more markers, but the manner in which the position of a single marker, preferably made up of an array of marker elements, changes through a series of images still permits the lens to be calibrated in a manner similar to that described above.

Furthermore, whilst it is preferably for the marker or markers to be at a known distance, this “known distance” may be either a fixed and/or predetermined distance, or maybe a distance that is determined and/or obtained as part of the operation of the system. In this way, the distance is not “known” at the start, but may be determined and/or obtained part way through the operation of the system. Additionally, when using multiple markers having an array of marker elements, the relative ratios of distances between different marker elements on different markers can be used, so the distance from the markers to the camera may be estimated. This estimate may still be a known distance.

Whilst the previous embodiments describe a marker which preferably has a linear array of marker elements, specifically a strip of marker elements, it will be apparent that the (or each) marker in any embodiment may comprise a two dimensional array such as a pair of linear arrays side by side or even a rectangular or square arrangement of elements.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A lens calibration system for calibrating a lens of an image capture device, the lens calibration system comprising:
a processor configured to receive from the image capture device a series of image frames of a scene at different rotational positions of the image capture device;
the processor being configured to:
identify in the series of image frames elements representing a first marker located at a first known distance from the image capture device and a second marker located at a second known distance from the image capture device, the first and the second known distances being different to one another;
track the identified elements representing each marker across the series of image frames;
process the tracked elements to determine a characteristic parameter of the lens of the image capture device; and
build a lens model for the image capture device in dependence on the determined characteristic parameter of the lens.

2. A lens calibration system for calibrating a lens of an image capture device, the lens calibration system comprising:
a processor configured to receive from the image capture device a series of image frames of a scene at different rotational positions of the image capture device;
the processor being configured to:
identify in the series of image frames one or more elements representing one or more markers located at a distance from the image capture device;
track the identified element(s) representing each marker across the series of image frames;
process the tracked element(s) to determine a characteristic parameter of the lens of the image capture device; and
build a lens model for the image capture device in dependence on the determined characteristic parameter of the lens.

3. The lens calibration system of claim 1, the processor further being configured to identify in the series of image frames elements representing a third marker located at a third known distance from the image capture device; the third known distance being different to both the first and the second known distances.

4. The lens calibration system of claim 1, wherein the identified elements representing each marker are arranged as an array along a longitudinal axis of that marker.

5. The lens calibration system of claim 1, the received series of image frames comprising image frames captured of the scene at different zoom and focal length settings of the image capture device.

6. The lens calibration system of claim 1, wherein the determined characteristic parameter of the lens is the entrance pupil location of the lens and/or the lens distortion and/or the chromatic aberration of the lens.

7. The lens calibration system of claim 1, the received series of image frames comprising a set number of image frames per second captured repeatedly of the scene at different rotational positions of the image capture device spanning a known duration.

8. The lens calibration system of claim 1, the received series of image frames comprising a set number of image frames per second captured of the scene at a desired zoom and focal length settings of the image capture device.

9. The lens calibration system of claim 1, wherein the different rotational positions of the image capture device are about a rotational axis parallel to the longitudinal axis of the markers.

10-11. (canceled)

12. The lens calibration system of claim 7, wherein the desired zoom is selected from a range of 7 zoom settings and the desired focal length is selected from a range of 5 focus settings.

13. The lens calibration system of claim 1, the processor being configured to identify one element of the identified elements representing a marker having a visually different appearance to the rest of the identified elements as a reference feature element for that marker.

14. The lens calibration system of claim 1, the processor being configured to identify the colour of the identified elements representing a marker from a range of available colours.

15. The lens calibration system of any of claims 10, the processor being configured to identify an element having a colour different to the colour of the rest of the identified elements representing a marker as the reference feature element for that marker.

16. The lens calibration system of claim 1, wherein the identified elements representing a marker represent a string of lights, or a strip of LED lights.

17. The lens calibration system of claim 13, wherein each element of the identified elements represents a light of the string of lights or LED lights that is switched on.

18. The lens calibration system of claim 11, the processor being configured to distinguish between the markers in dependence on the colour of the identified elements representing each marker.

19-20. (canceled)

21. A method of lens calibration for calibrating a lens of an image capture device, the method comprising:
carrying out the following steps by a processor:
receiving from the image capture device a series of image frames of a scene at different rotational positions of the image capture device;
identifying in the series of image frames elements representing a first marker located at a first known distance from the image capture device and a second marker located at a second known distance from the image capture device, the first and the second known distances being different to one another;
tracking the identified elements representing each marker across the series of image frames;
processing the tracked elements to determine a characteristic parameter of the lens of the image capture device; and
building a lens model for the image capture device in dependence on the determined characteristic parameter of the lens.

22-26. (canceled)

27. A system according to claim 2, wherein the processor is configured to identify at least two markers.

28. A system according to claim 18, wherein a first marker is at a first distance from the image capture device and the second marker at a second distance from the image capture device, the first and second distances being different.

29. A system according to claim 18, wherein the or each marker is at a known distance from the image capture device, the distances being different to one another.

30-34. (canceled)
